(19) United States
(12) Patent Application Publication
(10) Pub. No.: US 2018/0216683 A1
(43) Pub. Date: Aug. 2, 2018

(54) DISC BRAKE

(71) Applicant: Hitachi Automotive Systems, Ltd., Hitachinaka-shi, Ibaraki (JP)

(72) Inventors: Hayuru INOUE, Ayase-shi (JP); Sadatomo MATSUMURA, Isehara-shi (JP); Syoichi NOGUCHI, Kofu-shi (JP)

(21) Appl. No.: 15/747,553

(22) PCT Filed: Jul. 14, 2016
(86) PCT No.: PCT/JP2016/070790

§ 371 Date: Jan. 25, 2018

(30) Foreign Application Priority Data
Aug. 31, 2015 (JP) 2015-171520

(51) Int. Cl. F16D 65/28; F16D 55/226; F16C 1/18; F16D 65/18; B60T 1/06; B60T 13/58

(52) U.S. Cl. CPC F16D 65/28; F16D 55/226; F16C 1/18; F16D 55/227; B60T 1/065; B60T 13/588; F16D 65/18

(57) ABSTRACT

This disc brake includes: a carrier; a caliper (13); a pressing mechanism (81); and a cable (16). A center (0) of a rotation of the caliper (13) with respect to the carrier (11) is configured so as to be arranged in an orientation direction of an elastic force (F) which the caliper (13) receives and in which the cable (16) returns to a straight shape.

### TECHNICAL FIELD

The present invention relates to a disc brake. Priority is claimed on Japanese Patent Application No. 2015-171520, filed on Aug. 31, 2015, the content of which is incorporated herein by reference.

### BACKGROUND ART

A disc brake may include a configuration in which a part of a brake cable is housed in a casing and a curve portion of this casing made of a member with a stiffness to receive a return by the curve of the cable (for example, Patent Document 1).

### CITATION LIST

### Patent Literature

[Patent Document 1] Japanese Unexamined Patent Application, First Publication No. 2007-255597

### SUMMARY OF INVENTION

### Problem to be Solved by the Invention

The above casing receives the return by the curve of the cable. This configuration prevents a caliper from being oblique with respect to the disc by elastic force of the cable. However, when the casing has a stiffness so as to resist the elastic force of the cable, there is a possibility that there will be an increase in weight.

The present invention provides a disc brake that can prevent weight from increasing and can prevent a caliper from being inclined with respect to the disc.

### Solution to Problem

According to the present invention, a disc brake includes: a carrier which supports a pair of pads such that the pair of pads that are arranged at both sides of a disc are capable of sliding; a caliper which is supported by the carrier, is configured to cause a piston to fit into a bore of a cylinder that is a cylindrical shape having a bottom portion such that the piston is capable of sliding, and is configured to cause the pair of pads to contact with the disc by a movement of the piston; a pressing mechanism which protrudes from a bottom of the cylinder and is configured to cause a pressing force to be generated in a movement direction of the piston; and a cable which is configured to actuate the pressing mechanism and engage with the caliper. A center of rotation of the caliper with respect to the carrier is configured so as to be arranged in an orientation direction of an elastic force which the caliper receives and in which the cable returns to a straight shape.

### Advantageous Effects of Invention

The above disc brake can prevent weight from increasing and can prevent a caliper from being oblique with respect to the disc.

### BRIEF DESCRIPTION OF DRAWINGS

FIG. 1 is a plan view showing a disc brake according to a first embodiment of the present invention.

FIG. 2 is a sectional side view showing the disc brake according to the first embodiment of the present invention.

FIG. 3A is a plan view showing a bracket of the disc brake, an operation wire, and a cable according to the first embodiment of the present invention.

FIG. 3B is a sectional side view showing a bracket of the disc brake, an operation wire, and a cable according to the first embodiment of the present invention.

FIG. 4 is a plan view showing a disc brake according to a second embodiment of the present invention.

FIG. 5 is a plan view showing a disc brake according to a third embodiment of the present invention.

### DESCRIPTION OF EMBODIMENTS

### First Embodiment

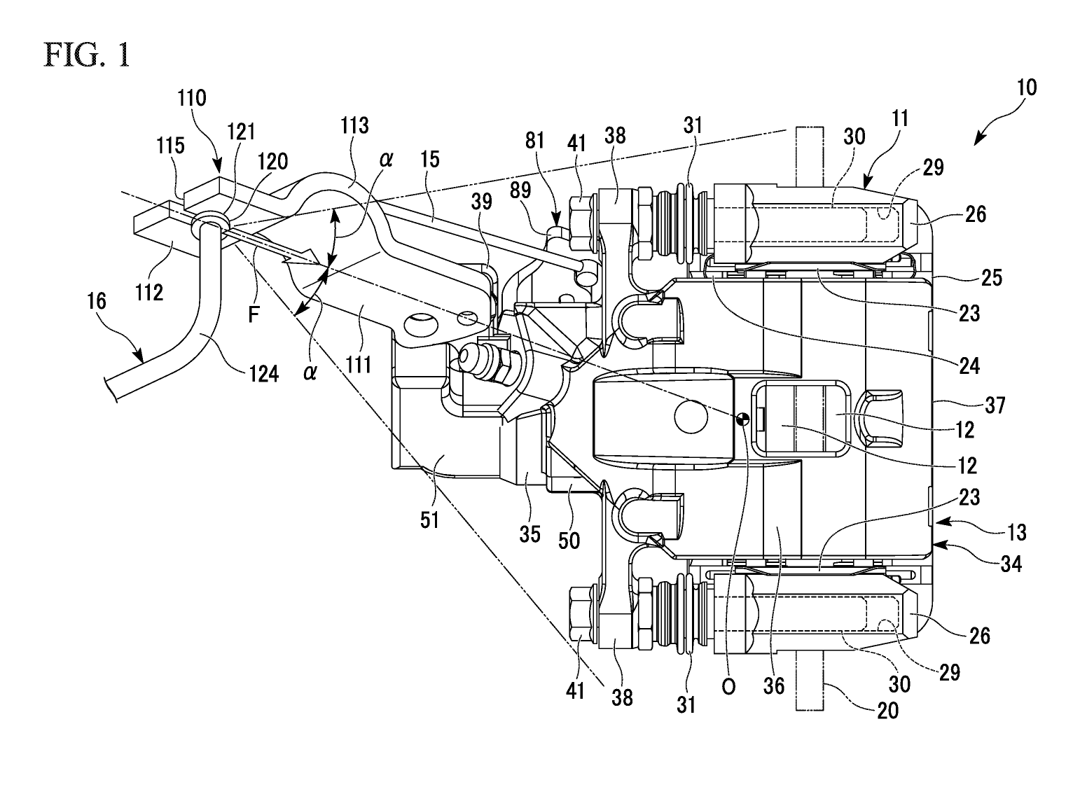

A first embodiment will be described with reference to FIGS. 1 to 3B. A disc brake 10 of the first embodiment shown in FIG. 1 includes a carrier 11, a pair of friction pads 12 (pads), a caliper 13, an operation wire 15 for a parking brake, and a cable 16 for the parking brake.

As shown in FIG. 1, the carrier 11 is arranged so as to straddle an outer diameter side of a disc 20 that rotates with a wheel (not shown) that is a braking object. The carrier 11 is fixed to a non-rotation part of the wheel (not shown). The pair of friction pads 12 is supported by the carrier 11 so as to be capable of sliding in an axis direction of the disc 20 in a state where the pair of friction pads 12 are arranged to face both faces of the disc 20. The caliper 13 is supported by the carrier 11 so as to be capable of sliding in the axis direction of the disc 20 in a state straddling an outer diameter side of a disc 20. The caliper 13 applies a friction resistance to the disc 20 by contacting and pushing the pair of friction pads 12 to the disc 20. Hereinafter, a radial direction of the disc 20 is referred to as a disc radial direction, the axis direction of the disc 20 is referred to as a disc axis direction, and a rotation direction of the disc 20 is referred to as a disc rotation direction.

The carrier 11 includes an inner side pad support part 24, an outer side pad support part 25, and a pair of coupling parts 26. The inner side pad support part 24 supports both sides of the disc rotational direction of the friction pad 12 of an inner side that is an inside in a vehicle width direction via a pair of pad guides 23. The outer side pad support part 25 supports the friction pad 12 of an outer side that is an outside in a vehicle width direction via a pair of pad guides 23. The pair of coupling parts 26 are separated in the disc rotation direction, extends in the disc axis direction, and couples with the inner side pad support part 24 and an outer side pad support part 25. The pair of coupling parts 26 is arranged so as to straddle the outer diameter of the disc 20.

In the carrier 11, a pair of guide holes 29 is penetrated from the inner side along the disc axis direction at the pair of coupling parts 26 that are an outside of the disc radial direction in both ends of the disc rotation direction. That is, one guide hole 29 is penetrated at one coupling part 26 and the other guide hole 29 is penetrated at the other coupling part 26. The pair of sliding pins 30 of the caliper 13 are respectively inserted in the pair of guide holes 29 from the inner side so as to be capable of sliding in the disc axis direction. That is, one sliding pin 30 is inserted in one guide hole 29 and the other sliding pin 30 is inserted in the other guide hole 29. The pair of sliding pins 30 are inserted in the pair of guide holes 29, thereby the caliper 13 including the pair of sliding pins 30 is supported by the carrier 11 including the pair of guide holes 29 so as to be capable of sliding. A part between the caliper 13 of the pair of sliding pins 30 and the carrier 11 is covered with a pair of boots 31 that is extendable and contractible.

The caliper 13 includes a caliper body 34 that is supported by the carrier 11 via the sliding pin 30 in the state straddling the disc 20. This caliper body 34 includes a cylinder 35, a bridge part 36, a claw part 37, a pair of arm parts 38, and a bracket attaching part 39. The caliper body 34 of the caliper 13 is provided such that the cylinder 35 is arranged at one side of the disc 20 in the axis direction, the claw part 37 is arranged at the other side of the disc 20 in the axis direction, the bridge part 36 connecting the claw part 37 and the cylinder 35 straddles the disc 20. The caliper 13 is what is called a first type caliper. The above pair of sliding pins 30 is fixed to the pair of arm parts 38 so as to be along the disc axis direction and to protrude to the claw part 37 side. The pair of sliding pins 30 is fixed to the pair of arm parts 38 by a pair of bolts 41 screwed from the inner side.

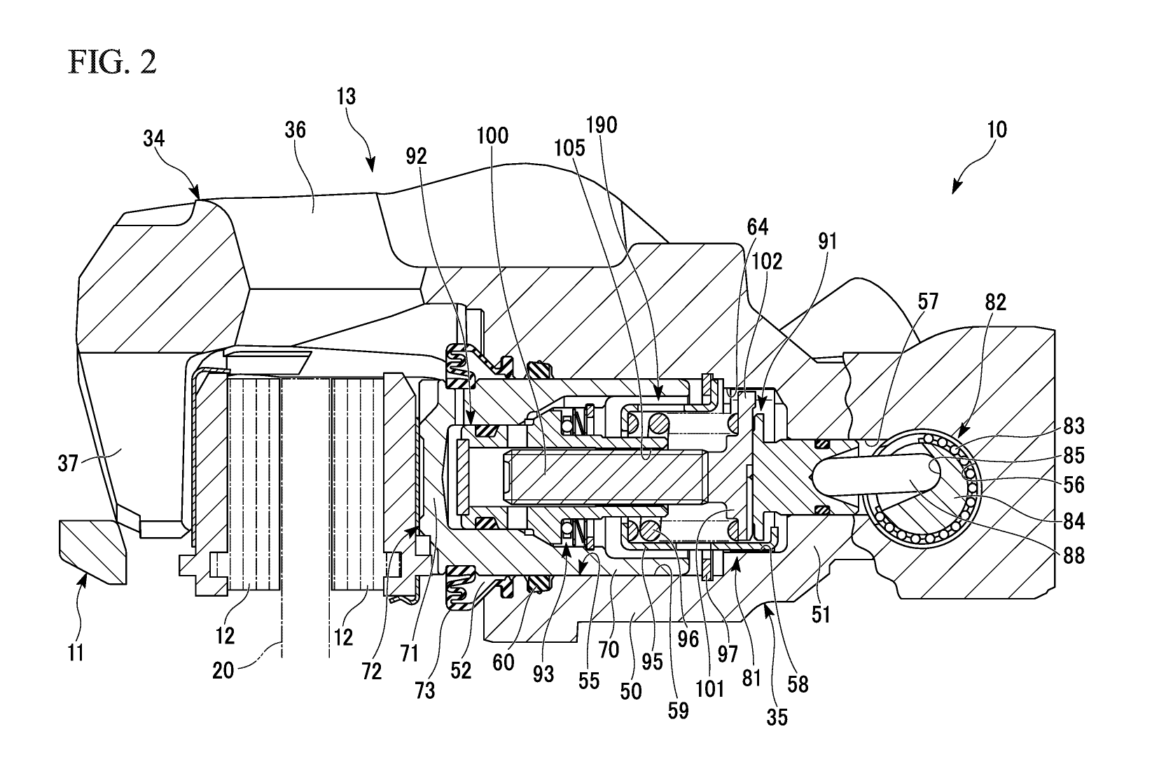

As shown in FIG. 2, the cylinder 35 of the caliper body 34 includes a cylinder tubular portion 50 formed in a tubular shape and a cylinder bottom portion 51 closing one end of the axis direction of the cylinder tubular portion 50, and the cylinder 35 is formed in a cylindrical shape having a bottom. The cylinder 35 causes an opening portion 52 to face with respect to the inner side friction pad 12. Here, a bottom surface and an inner peripheral surface of the cylinder tubular portion 50 are referred as to a bore 55. A cam hole 56 is formed at the cylinder bottom portion 51 of the caliper body 34 spaced from the bottom of the bore 55 and along an orthogonal direction to the axis direction of the cylinder 35. A cross-sectional shape of the cam hole 56 is a circular shape. A bottom portion hole 57 that penetrates from a center position of the bottom surface to the cam hole 56 along the axis direction of the cylinder 35 is formed at the cylinder bottom portion 51.

In an inner circumference of the bore 55 of the cylinder tubular portion 50 of the caliper body 34, a back position hole 58 is formed in the most cylinder bottom portion 51 side. A sliding hole 59 is formed in the opening portion 52 side closer than the back position hole 58 and a diameter of sliding hole 59 is larger than a diameter of the back position hole 58. A piston seal 60 that seals between a piston 72 (described later) and the cylinder 35 is held in a vicinity of an end portion opposite to the back position hole 58 of the sliding hole 59. An axis direction groove 64 that is recessed in a radial direction, extends in the axis direction, and is formed in a recessed shape is formed in an inner peripheral surface of the back position hole 58 of the cylinder tubular portion 50.

The caliper 13 includes the piston 72 that is formed in a cylindrical shape having a lid. The piston 72 has a tubular portion 70 that is tubular and a lid portion 71 that is a disc-shape. The piston 72 is housed in the bore 55 formed in the caliper body 34 of the cylinder 35 in a posture facing the tubular portion 70 side to the cylinder bottom portion 51 side. In particular, the piston 72 is fitted into the sliding hole 59 of the bore 55 so as to be capable of sliding.

The caliper 13 includes a boot 73 between an inner peripheral portion of the opening portion 52 side of the cylinder 35 and an outer peripheral portion of the lid portion 71 side of the piston 72. The boot 73 is extendable and contractible. A gap between the piston 72 and the bore 55 of the cylinder 35 is covered with the boot 73 in an outside.

The caliper 13 causes the piston 72 that is fitted into the bore 55 so as to be capable of being slidable to slide in the sliding hole 59 of the cylinder 35 and to move in a direction of the friction pad 12 from the cylinder 35 by a brake fluid pressure introducing between the cylinder 35 and the piston 72. By this movement of the piston 72, the caliper 13 causes these friction pads 12 to contact with the disc-shaped disc 20 by grasping the pair of friction pads 12 from the both side of the pair of friction pads 12 by the piston 72 and the claw part 37.

During normal braking by an operation of pressing a brake pedal, as described above, the piston 72 slides in the cylinder 35 and protrudes toward a direction of the claw part 37 from the cylinder 35 by a brake fluid pressure introducing in the cylinder 35 from a master cylinder (not shown). Thereby, a braking force is generated by contacting the pair of friction pads 12 with the disc 20. On the other hand, the caliper 13 includes a pressing mechanism 81 that causes the pair of friction pads 12 to press the disc 20 and to generate the braking force by causing the piston 72 provided in the caliper 13 to propel mechanically without using the brake fluid pressure. That is, the caliper 13 is a built-in caliper including a handbrake.

The pressing mechanism 81 includes a cam mechanism 82 that is housed in the cylinder 35. The cam mechanism 82 includes a bearing 83 that is fitted into the cam hole 56 of the above caliper body 34 and is formed in a circular arc shape, and a cam main body 84 that is supported by the cam hole 56 via the bearing 83 so as to be capable of rotating and is formed in a substantially columnar shape. A cam concave portion 85 that is recessed in a substantially V shape from an outer peripheral surface of a radial direction toward a center direction is formed in the cam main body 84. The most concave position of the cam concave portion 85 is offset with respect to a center axis direction of the cam main body 84.

The cam mechanism 82 includes a cam rod 88 of which one end side is inserted into the cam concave portion 85 and the other end side is arranged into the bottom portion hole 57. This cam rod 88 causes a protrusion amount from the cam main body 84 to change by a shape of the cam concave portion 85 when the cam main body 84 is driven to rotate around an axis along an orthogonal direction with respect to the cylinder 35. That is, the bottom portion of the cam concave portion 85 is offset with respect to a center of the cam main body 84, thereby a position of the bottom portion of the cam concave portion 85 is advanced and retracted with respect to the bottom portion hole 57 when the cam main body 84 rotates, and the cam concave portion 85 causes the protrusion of the cam rod 88 contacted with the bottom portion to change. Here, a part of the cam main body 84 protrudes from the cylinder bottom portion 51 of the cylinder 35. The cam mechanism 82 includes a lever member 89, shown in FIG. 1, fixed to this protrusion portion. The cam main body 84 rotates integrally with the lever member 89 when the lever member 89 is driven to rotate.

As shown in FIG. 2, the pressing mechanism 81 includes a linear transmission mechanism 190 that is housed in the cylinder 35 and is moved in an axis direction of the cylinder 35 by pressing using the cam rod 88 of the cam mechanism 82. The linear transmission mechanism 90 includes a push rod 91, a clutch member 92, an adjustment part 93 that adjusts a position between the push rod 91 and the clutch member 92, a cover member 95, and a push rod biasing spring 96. The cover member 95 is locked on the cylinder 35 by a stopper ring 97 that is formed in a C shape and a movement of the linear transmission mechanism 90 in a direction of the opening portion 52 is restricted.

The push rod 91 includes a screw shaft portion 100 and a flange portion 101 that is a disc-shape. A convex portion 102 that protrudes radially outward from the flange portion 101 is formed integrally with an outer peripheral portion of the flange portion 101. This convex portion 102 is fitted on the axis direction groove 64 of back position hole 58 of the cylinder tubular portion 50. Therefore, a rotation of the push rod 91 with respect to the cylinder 35 is restricted. The clutch member 92 includes a female screw 105 that is screwed on the screw shaft portion 100 of the push rod 91.

The pressing mechanism 81 causes the cam mechanism 82 including the lever member 89 to rotate, thereby the pressing mechanism 81 presses the push rod 91 of the linear transmission mechanism 90 by the cam rod 88. By this press, the clutch member 92 linearly moves in an axis direction and causes the piston 72 to forcibly slide to the friction pad 12 side with respect to the cylinder 35. That is, the lever member 89 protrudes from the cylinder bottom portion 51 and the pressing mechanism 81 causes the pressing force in a movement direction of the piston 72 by a rotation input to the lever member 89. The adjustment part 93 adjusts a screwing amount of the screw shaft portion 100 of the push rod 91 and the female screw 105 of the clutch member 92 in accordance with an abrasion of the pair of friction pads 12.

As shown in FIG. 1, the caliper 13 includes a bracket 110 that is fixed to the bracket attaching part 39 of the caliper body 34. The bracket 110 guides the cable 16 to a parking brake mechanism. An attaching base part 111 that is fixed to the bracket attaching part 39 is provided in one end of the bracket 110 and a cable support part 112 that is supports a joint part 120 of a terminal of the cable 16 is provided the other of the bracket 110. The bracket 110 includes a wire guide part 113 guiding the operation wire 15 that is included in the cable 16 and extended from the terminal of the cable 16. The wire guide part 113 is provided between the attaching base part 111 and the cable support part 112.

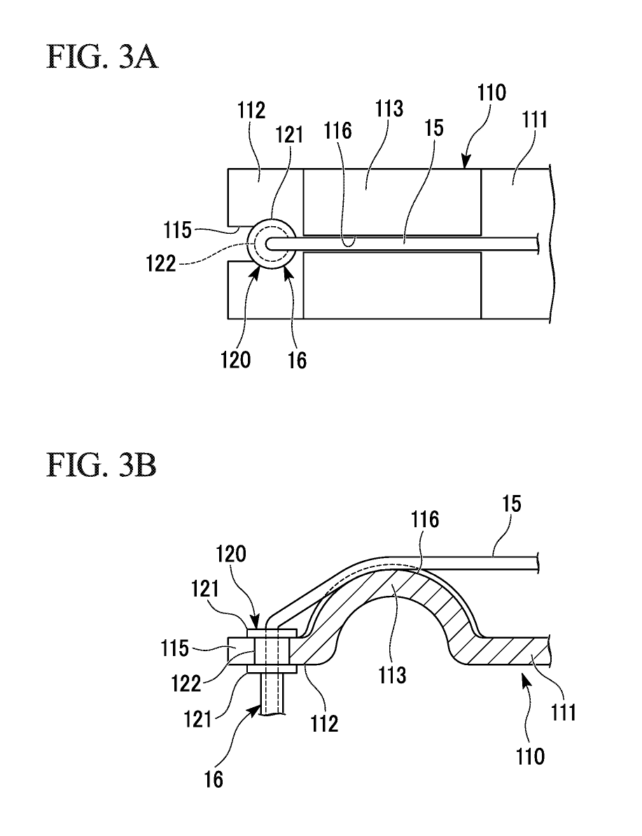

A locking groove 115 that penetrates in an opposite direction of the wire guide part 113 is formed in the cable support part 112. As shown in FIG. 3B, the wire guide part 113 is formed in a circular arc shape, and a guide groove 116 is formed radially outward from the wire guide part 113 so as to connect the cable support part 112 to the attaching base part 111.

As shown in FIG. 3B, a pair of flange portions 121 is provided in the joint part 120 of the terminal of the cable 16. An insertion portion 122 of which a diameter is smaller than a diameter of the flange portion 121 is provided between the pair of flange portions 121. The insertion portion 122 is inserted into the locking groove 115 from a side opposed to the wire guide part 113. In this case, the cable support part 112 is held between the pair of flange portions 121. Here, the cable 16 is a straight shape in a natural state, and is elastically deformed when external force is applied. As shown in FIG. 1, a bending portion 124 occurs at a front side than the joint part 120 when being attached to the vehicle. An elastic force F of the cable 16 and the operation wire 15 including the bending portion 124 presses the joint part 120 of the terminal to the end portion of the wire guide part 113 side of the locking groove 115. Thereby, the joint part 120 of the cable 16 engages with the bracket 110 of the caliper 13 and the elastic force F of the cable 16 and the operation wire 15 is transmitted to the caliper body 34 from the bracket 110 as a pressing force. The bracket 110 is an elastic force input member that the elastic force F of the cable 16 and the operation wire 15 in the caliper 13 is input. The bracket 110 is an elastic force transmission member that transmits the elastic force F of the cable 16 and the operation wire 15 to the caliper body 34.

As shown in FIG. 3A and FIG. 3B, the operation wire 15 extending from the terminal of the cable 16 is engaged with the guide groove 116 formed in the wire guide part 113. As shown in FIG. 1, a terminal of the operation wire 15 is connected to the lever member 89 of the pressing mechanism 81.

The operation wire 15 is pulled in a direction in which an extending amount is reduced with respect to the cable 16 by the parking brake mechanism (not shown, for example, a parking brake lever for the manual operation, a parking brake pedal for the foot-step operation, an electric cable puller by a motor drive or the like). When the operation wire 15 is pulled with respect to the cable 16, the lever member 89 of the pressing mechanism 81 rotates ant the lever member 89 and the cam main body 84 shown in FIG. 2 rotates integrally. Thereby, the cam main body 84 presses the push rod 91 via the cam rod 88. The clutch member 92 linearly moves in the axis direction and presses the piston 72 by pressing the push rod 91, and the piston 72 is forcibly slid to the friction pad 12 side with respect to the cylinder 35. As a result, the piston 72 and the claw part 37 press the pair of friction pads 12 to the disc 20 and the braking force is generated. The cable 16 and the operation wire 15 shown in FIG. 1 actuate the pressing mechanism 81.

In the caliper 13, because the pair of sliding pins 30 is fitted into the pair of guide holes 29 of the carrier 11 so as to be capable of sliding, the clearance is provided between the pair of sliding pins 30 and the pair of guide holes 29. As shown in FIG. 1, when viewed from the outside in the radial direction of the disc along a line orthogonal to the center axis direction of the disc 20 passing through a center positon of a width direction of the caliper 13 (hereinafter, referred to as “a caliper planar view”), the caliper 13 is capable of rotating around a gravity center O with respect to the carrier 11 by the above clearance. The caliper 13 rotates around the gravity center O depending on a direction of the elastic force by receiving the elastic force from the cable 16 and the operation wire 15. That is, the gravity center O is a rotation center when the caliper 13 rotates with respect to the carrier 11 based on the elastic force. Here, the center positon of the width direction of the caliper 13 is, in other words, the center positon between the pair of sliding pins 30, and is the position of the center axis line of the cylinder 35 and the piston 72. When the caliper 13 rotates around the gravity center O, in the caliper planar view, the center axis line of the cylinder 35 and the piston 72 with respect to the disc 20 corresponds and inclines.

The bracket 110 receives the elastic force F such that the gravity center O of the caliper 13, that is a center O of the rotation of the caliper 13 with respect to the carrier 11 is positioned forward in an orientation direction of the elastic force F in the caliper planar view. In other words, in this disc brake 10, in the caliper planar view, the center O of the rotation of the caliper 13 with respect to the carrier 11 is arranged forward in the orientation direction of the elastic force F which the caliper 13 receives and in which the cable 16 and the operation wire 15 return to a straight shape.

In particular, in the caliper planar view, the bracket 110 receives the elastic force F such that a gravity center O of the caliper 13 that is a center O of the rotation of the caliper 13 with respect to the carrier 11 is positioned between two lines in which an angle a between the two lines which extend from a proximal end position toward the orientation direction side of the elastic force F and an orientation line which points forward in the orientation direction of the elastic force F that extends from the proximal end position is within 30 degrees. The bracket 110 preferably receives such that the orientation line which points forward in the orientation direction of the elastic force F passes through the gravity center O of the caliper 13, that is the center O of the rotation of the caliper 13 with respect to the carrier 11 in the caliper planar view. The proximal end of the elastic force F is a portion in which the cable 16 is locked by the locking groove 115 formed in the bracket 110.

In the patent document 1, a part of the brake cable is housed in the casing and this curving portion of the casing is formed by a member with the stiffness to receive a return by the curve of the cable. Consequently, the casing receives the return of the curve of the brake cable, and thereby the incline of the caliper with respect to the carrier by the elastic force of the brake cable, that is, the incline with respect to the disc, can be prevented. However, to obtain a stiffness that can resist the elastic force of the brake cable, the weight of the casing increases and the cost increases. Specifically, in a case where a whole cable curves, because it is necessary for a wide range of the stiffness of the casing to heighten, the weight of the casing increases and the cost increases. It is difficult for the brake cable to follow because of a high stiffness of the casing and a displacement of the cylinder is obstructed when the friction pad abrades. As a result, a drag of the brake increases and the braking force is unstable because of preventing a displacement of the cylinder.

Compared with this, in the disc brake 10 of the first embodiment, in the caliper planar view, the gravity center O that is the center of the rotation of the caliper 13 is arranged forward with respect to the carrier 11 in the orientation direction of the elastic force F which the caliper 13 receives and in which the cable 16 and the operation wire 15 return to a straight shape. Thereby, it is not necessary to increase the stiffness of the casing and to add another part, and it can suppress an incline of the carrier 11 of the caliper 13 due to the moment caused by the elastic force F, that is, the incline of the caliper 13 with respect to the disc 20. Accordingly, the increase of the weight and the incline of the caliper 13 with respect to the disc 20 can be limited. Furthermore, even if a plurality of kinds of vehicle structures and layouts of the cables are different from each other, the incline of the caliper 13 with respect to the disc 20 can be reduced by only changing the bracket 110.

Here, when the elastic force of the cable 16 and the operation wire 15 act on the caliper body 34 of the caliper 13, the moment acts on the piston 72 that is displaced integrally with the caliper body 34 by the force and the pair of pads 12. By this moment, especially when the liquid pressure in the caliper 13 is low, the caliper body 34, the piston 72, and the pair of pads 12 are inclined with respect to the disc 20, and unevenness of a surface pressure of the pair of pads 12 and the disc 20 occurs. This promotes a displacement of a friction force and the occurrence of abnormal noise called moan noise.

As above, because the disc brake 10 of the first embodiment can suppress the incline of the carrier 11 of the caliper 13 by the elastic force F, that is, the incline of the caliper 13 with respect to the disc 20, the occurrence of abnormal noise called moan noise can be suppressed.

In the disc brake 10 of the first embodiment, in the caliper planar view, the bracket 110 receives the elastic force F such that a gravity center O of the caliper 13 that is a center O of the rotation of the caliper 13 with respect to the carrier 11 is positioned between two lines in which the angle a between the two lines which extend from a proximal end position toward the orientation direction side of the elastic force F and an the orientation line which points forward in the orientation direction of the elastic force F that extends from the proximal end position is within 30 degrees. The angle a between the line and the orientation line is within 30 degrees. Accordingly, the occurrence of abnormal noise can be suppressed. When the angle a is within 30 degrees, the occurrence frequency of abnormal noise is within the acceptable range. When the angle a exceeds 30 degrees, the occurrence frequency of abnormal noise is outside the acceptable range. When the range of the angle is 0 degrees, that is, in the caliper planar view, the bracket 110 receives the elastic force F such that the orientation line directed to the front of the elastic force F passes through the gravity center O of the caliper 13 that is a center O of the rotation of the caliper 13 with respect to the carrier 11, the occurrence frequency of abnormal noise is minimal.

### Second Embodiment

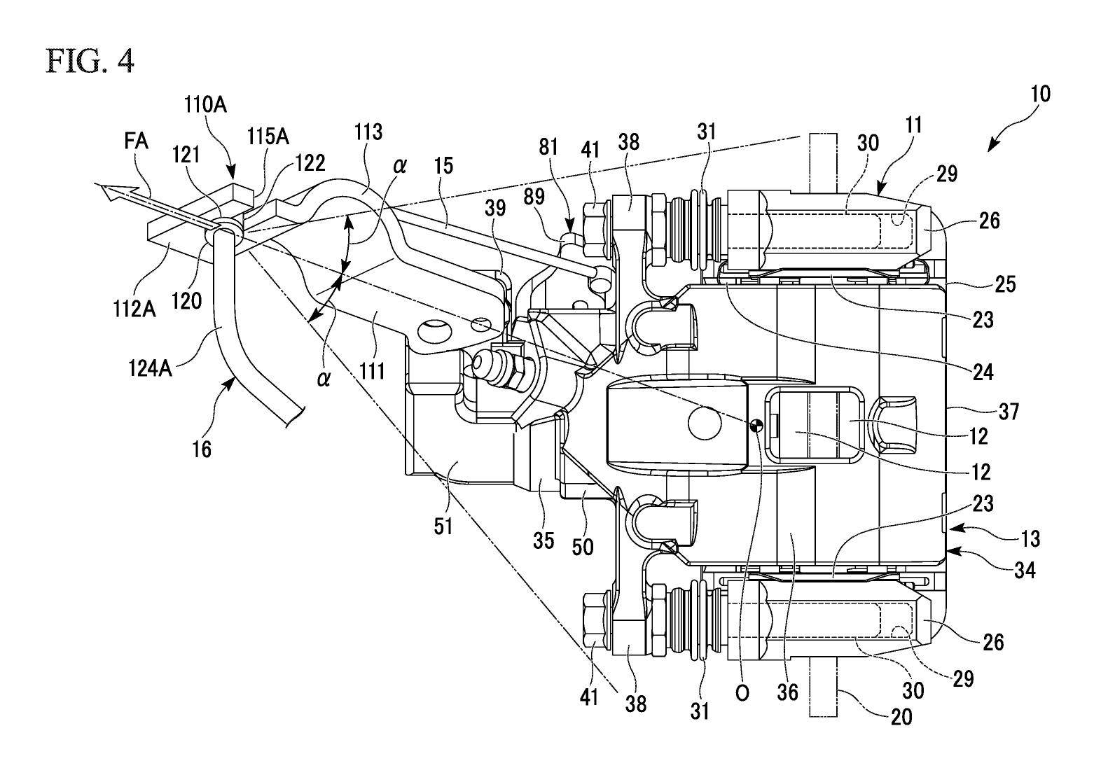

Next, a difference between the first embodiment and a second embodiment will be described mainly with reference to mainly FIG. 4.

In common parts with the first embodiment, the same reference numerals and the same names are used for the elements which are identical to those of the first embodiment.

The caliper 13 of the second embodiment includes a bracket 110A having a cable support part 112A, a portion of which differs from the first embodiment. The locking groove 115 that opens in a direction orthogonal to an arrangement direction of the cable support part 112A and the wire guide part 113 is formed in the cable support part 112A.

In the second embodiment, a bending portion 124A occurs in the cable 16 when being attached to the vehicle. The elastic force FA of the cable 16 including this bending portion 124A and the operation wire 15 presses the joint part 120 of the terminal to the edge portion opposite to the wire guide part 113 of the locking groove 115A. Thereby, the cable 16 engages with the bracket 110A of the caliper 13, and the elastic force FA of the cable 16 and the cable 15 is transmitted as a pulling force from the bracket 110A to the caliper body 34. The bracket 110A is an elastic force input member that the elastic force FA of the cable 16 and the operation wire 15 in the caliper 13 is input. The bracket 110A is an elastic force transmission member that transmits the elastic force FA of the cable 16 and the operation wire 15 to the caliper body 34.

The bracket 110A, in the caliper planar view shown in FIG. 4, receives the elastic force FA such that the gravity center O of the caliper 13, that is a center O of the rotation of the caliper 13 with respect to the carrier 11 is positioned backward in an orientation direction of the elastic force FA. In other words, in this disc brake 10, in the caliper planar view, the gravity center O of the caliper 13, that is the center O of the rotation of the caliper 13 with respect to the carrier 11 is arranged in back of the orientation direction of the elastic force FA which the caliper 13 receives and in which the cable 16 and the operation wire 15 return to a straight shape.

In particular, in the caliper planar view, the bracket 110A receives the elastic force FA such that a gravity center O of the caliper 13, that is a center O of the rotation of the caliper 13 with respect to the carrier 11 is positioned between two lines in which an angle a between the two lines which extend opposite to the orientation direction of the elastic force FA from a proximal end position and an extended line of an orientation line of the elastic force FA which extends opposite to the orientation direction of the elastic force FA from the proximal end position is within 30 degrees. The bracket 110A preferably receives such that an extended line which points backward the orientation direction of the orientation line of the elastic force FA passes through the gravity center O of the caliper 13, that is the center O of the rotation of the caliper 13 with respect to the carrier 11 in the caliper planar view.

The disc brake 10 of the second embodiment can obtain the same effect as the first embodiment.

### Third Embodiment

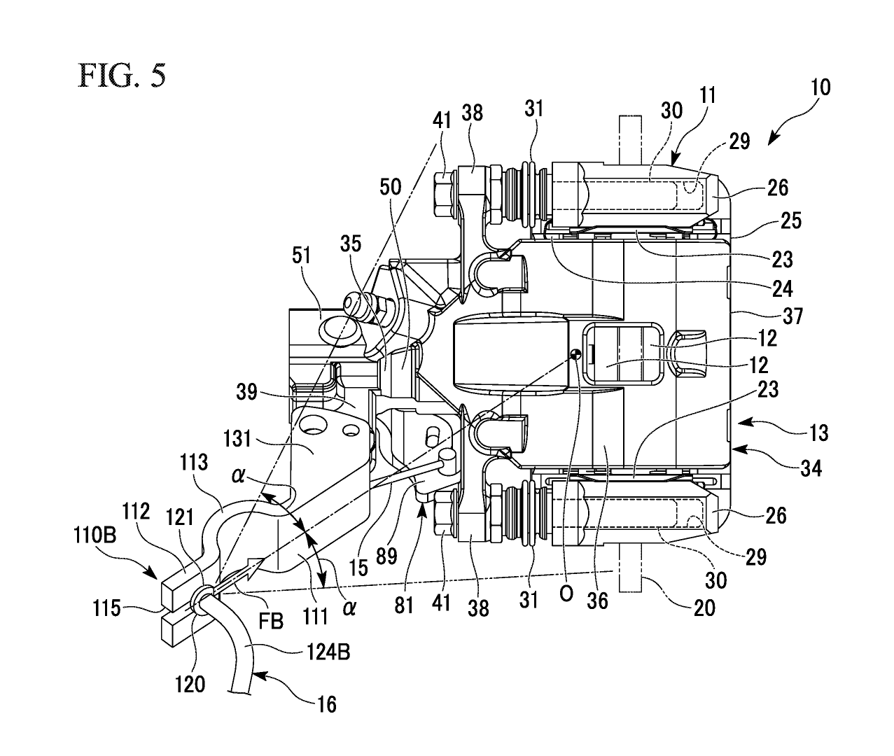

Next, a difference between the first embodiment and a third embodiment will be mainly described with reference to mainly FIG. 5. In common parts with the first embodiment, the same reference numerals and the same names are used for the elements which are identical to those of the first embodiment.

The caliper 13 of the third embodiment includes a bracket 110B, a portion of which differs from the first embodiment. The bracket 110B includes an attaching main body part 131 that is bent from the attaching base part 111 and is fixed to the bracket attaching part 39 of the caliper body 34.

In the third embodiment, a bending portion 124B occurs in the cable 16 when being attached to the vehicle. The elastic force FB of the cable 16 including this bending portion 124B and the operation wire 15 presses the joint part 120 of the terminal to the edge portion of the wire guide part 113 side of the locking groove 115. Thereby, the cable 16 engages with the bracket 110B of the caliper 13, and the elastic force FB of the cable 16 and the cable 15 is transmitted as a pressing force from the bracket 110B to the caliper body 34. The bracket 110B is an elastic force input member that the elastic force FB of the cable 16 and the operation wire 15 in the caliper 13 is input. The bracket 110B is an elastic force transmission member that transmits the elastic force FB of the cable 16 and the operation wire 15 to the caliper body 34.

The bracket 110B, in the caliper planar view, receives the elastic force FB such that the gravity center O of the caliper 13, that is a center O of the rotation of the caliper 13 with respect to the carrier 11 is positioned forward in the orientation direction of the elastic force FB. In other words, in this disc brake 10, in the caliper planar view, the gravity center O of the caliper 13, that is the center O of the rotation of the caliper 13 with respect to the carrier 11 is arranged forward in the orientation direction of the elastic force FB which the caliper 13 receives and in which the cable 16 and the operation wire 15 return to a straight shape.

In particular, in the caliper planar view, the bracket 110B receives the elastic force FB such that a gravity center O of the caliper 13, that is a center O of the rotation of the caliper 13 with respect to the carrier 11 is positioned between two lines in which an angle a between the two lines which extend toward the orientation direction side of the elastic force FB from a proximal end position of the elastic force FB and an orientation line which points forward in the orientation direction of the elastic force FB that extends from the proximal end position is within 30 degrees. The bracket 110B preferably receives such that the extended line which points backward in the orientation direction of the orientation line of the elastic force FB passes through the gravity center O of the caliper 13, that is the center O of rotation of the caliper 13 with respect to the carrier 11 in the caliper planar view.

The disc brake 10 of the third embodiment can obtain the same effect as the first embodiment.

Here, depending on the direction of the elastic force of the cable 16 and the operation wire 15, instead of the locking groove 115 of the bracket 110B of the third embodiment, the locking groove that is the same as the locking groove 115A, may be formed, and the elastic force of the cable 16 and the operation wire 15 may press the joint part 120 of the terminal to the end edge portion opposite to the wire guide part 113 of the locking groove. In this case, if the orientation direction satisfies a relationship similar to the second embodiment, the third embodiment can obtain the same effect as the first embodiment.

The following aspect may be considered as a disc brake based on the above embodiment.

As a first aspect, a disc brake includes: a carrier which supports a pair of pads such that the pair of pads that are arranged at both sides of a disc are capable of sliding; a caliper which is supported by the carrier, causes a piston to fit into a bore of a cylinder that is a cylindrical shape having a bottom such that the piston is capable of sliding, and causes the pair of pads to contact with the disc by a movement of the piston; a pressing mechanism which protrudes from a bottom of the cylinder and causes a pressing force to generate in a movement direction of the piston; a cable which is configured to actuate the pressing mechanism and engages with the caliper. The center of the rotation of the caliper with respect to the carrier is arranged forward or backward in the orientation direction of the elastic force which the caliper receives and in which the cable and the operation wire return to a straight shape. Therefore, an increase of weight and incline of the caliper with respect to the disc can be suppressed.

As a second aspect, in the first aspect, a center of rotation is positioned between two lines in which an angle between two lines which extend from a proximal end position of an elastic force to an orientation direction side of the elastic force and an orientation line of the elastic force which extends from the proximal end position is within 30 degrees.

As a third aspect, in the first aspect, a center of rotation is positioned between two lines in which an angle between two lines which extend opposite to an orientation direction of an elastic force from a proximal end position and an extended line of an orientation line of the elastic force which extends opposite to the orientation direction of the elastic force from the proximal end position is within 30 degrees.

As a fourth aspect, in the second aspect or the third aspect, the caliper includes a bracket that is fixed to the caliper, and guides the cable to a parking brake mechanism, and the proximal end position is a part in which the cable is locked by a groove part formed in the bracket.

### INDUSTRIAL APPLICABILITY

The above disc brake can suppress the increase of the weight and the incline of the caliper with respect to the disc.

### REFERENCE SIGNS LIST

10: disc brake
11: carrier
12: friction pad (pad)
13: caliper
15: operation wire
16: cable
20: disc
35: cylinder
51: cylinder bottom portion p0 55: bore
72: piston
81: pressing mechanism
110, 110A, 110B: bracket
O: gravity (center of rotation)
F, FA, FB: elastic force

1. A disc brake comprising:
a carrier which supports a pair of pads such that the pair of pads that are arranged at both sides of a disc are capable of sliding;
a caliper which is supported by the carrier, is configured to cause a piston to fit into a bore of a cylinder that is a cylindrical shape having a bottom portion such that the piston is capable of sliding, and is configured to cause the pair of pads to contact with the disc by a movement of the piston;
a pressing mechanism which protrudes from a bottom of the cylinder and is configured to cause a pressing force to be generated in a movement direction of the piston; and
a cable which is configured to actuate the pressing mechanism and engage with the caliper, wherein
a center of rotation of the caliper with respect to the carrier is configured so as to be arranged in an orientation direction of an elastic force which the caliper receives and in which the cable returns to a straight shape.

2. The disc brake according to claim 1, wherein
a center of rotation is positioned between two lines in which an angle between two lines which extend from a proximal end position of an elastic force to an orientation direction side of the elastic force and an orientation line of the elastic force which extends from the proximal end position is within 30 degrees.

3. The disc brake according to claim 1, wherein
a center of rotation is positioned between two lines in which an angle between the two lines which extend opposite to an orientation direction of an elastic force from a proximal end position and an extended line of an orientation line of the elastic force which extends opposite to the orientation direction of the elastic force from the proximal end position is within 30 degrees.

4. The disc brake according to claim 2, wherein
the caliper includes a bracket that is fixed to the caliper, and is configured to guide the cable to a parking brake mechanism, and
the proximal end position is a part in which the cable is locked by a groove part formed in the bracket.

5. The disc brake according to claim 3, wherein
the caliper includes a bracket that is fixed to the caliper, and is configured to guide the cable to a parking brake mechanism, and
the proximal end position is a part in which the cable is locked by a groove part formed in the bracket.
